(19) United States
(12) Patent Application Publication
(10) Pub. No.: US 2022/0376722 A1
(43) Pub. Date: Nov. 24, 2022

(54) MULTIBAND ANTENNA BOOSTER ARCHITECTURE WITH A SINGLE SWITCH

(71) Applicant: IGNION, S.L., Barcelona (ES)

(72) Inventors: Jaume ANGUERA, Castello (ES); Aurora ANDÚJAR, Barcelona (ES); Carles PUENTE, Barcelona (ES)

(21) Appl. No.: 17/749,989

(22) Filed: May 20, 2022

Related U.S. Application Data
(60) Provisional application No. 63/191,334, filed on May 21, 2021.

(30) Foreign Application Priority Data
Dec. 27, 2021 (EP) 21217878.4

(51) Int. Cl. H04B 1/04; H04B 7/155; H04B 1/18; H01Q 5/335

(52) U.S. Cl. CPC H04B 1/0483; H04B 7/155; H04B 1/18; H01Q 5/335

(57) ABSTRACT

A wireless device operates in a plurality of frequency bands and/or frequency regions and comprises a radiating system having an RF transceiver, a booster element, a radiation booster, or a modular multi-stage element; a ground plane layer on a PCB, an external port connected to the RF transceiver, and a multiband and/or multi-region radiofrequency system that comprises a switch. The radiating system also comprises a feeding architecture that connects the antenna element or the booster element to the radiofrequency system, the feeding architecture comprising a feeding line connected to a booster or antenna element and at least two feeding line extensions that are connected to a switch of the radiofrequency system and to the feeding line. A multi-region radiofrequency system comprises a switch and at least two matching networks selectable through the switch, the at least two matching networks including two stages: a pre-matching stage and a common matching stage.

### CROSS REFERENCE TO RELATED APPLICATIONS

This application claims priority under 35 U.S.C. § 119(e) from U.S. Provisional Patent Application Ser. No. 63/191,334, filed May 21, 2021, claims priority under 35 U.S.C. § 119 to Application No. EP 21217878.4 filed on Dec. 27, 2021, the entire contents of which are hereby incorporated by reference.

### TECHNICAL FIELD

The present disclosure relates to the field of wireless devices that operate in multiple frequency bands and/or multiple frequency regions, the wireless devices comprising a smart radiating system that includes a radiofrequency system that comprises active elements like switches.

### BACKGROUND

Wireless devices able to operate in multiple regions and/or frequency bands including a smart radiating system that comprises a smart radiofrequency system provide a solution for covering large bandwidths by optimizing the bands allocation. Usually, those radiofrequency systems comprise switches in their architecture or other active circuit components that provide with losses and need a more complex layout for integrating the radiofrequency system in a real PCB (printed circuit board). Regarding switches, a switch contains one or more inputs and one or more outputs, even if a switch normally is bidirectional, meaning that a signal can travel from an input to an output and from an output to an input. The inputs normally are named poles P and the outputs throws T. So, an MPNT switch is a switch containing M poles and N throws, being M and N an integer number. If the switch contains just one pole P and two throws T, the switch is an SPDT or an SP2T switch (single pole-double throw), and similarly with other input/output configurations, as for example SPNT (single pole multiple throw), as for instance SP4T (one pole-four throws), or DP6T (double pole-6 throws). There also exists multiple path or multi-path switches, able to route or connect a pole to two or more throws simultaneously.

There exists in literature antenna systems comprising switches, like for example U.S. Pat. No. 10,141,655 B2, U.S. Pat. No. 10,418,704 B2, and KR 10-1490156 B1. Those antenna systems comprise conventional antennas that are space consuming and customized. So, a smart radiating system comprising radiation boosters like those described in, for example, the patent document U.S. Pat. No. 8,203,492 B2 is an advantageous solution. The U.S. Pat. No. 10,122,403 B2 discloses a multiband or multi-region wireless device that comprises a boosting element and a radiofrequency system comprising a tunable reactive element that can comprise a switch in some embodiments.

Reducing the number of switches and the number of circuit components comprised in a radiofrequency system simplifies the radiofrequency architecture or configuration and reduces the losses related to the radiofrequency system. So, in the context of the present disclosure, an active radiating system comprising a multi-band and/or multi-region radiofrequency system, advantageously comprising only one switch, is provided and disclosed. However, it has been found that when mounting such a radiofrequency system, comprising more than one matching networks connected to a same antenna element, those matching networks matching the radiating system at different bands of operation, a charging problem may appear between the circuit components comprised in the different matching networks, particularly when circuit components connected to ground are included.

Additionally, when mounting in a real PCB a multi-region radiofrequency system that includes a switch, a charging problem arises between the feeding line extensions needed for connecting the switch to the feeding line that is connected to the antenna element included in the radiating system. More concretely, the charging problem appears between the feeding line extensions comprised and configured for providing operation at different frequency regions. Those problems are overcome by the disclosed radiating system.

### SUMMARY

The present disclosure relates to a wireless device able to operate in more than one frequency bands and/or in more than one frequency regions, the wireless device comprising a smart radiating system that comprises an RF transceiver, at least one booster element or radiation booster or a modular multi-stage element, a ground plane layer, at least one external port connected to the RF transceiver, and a multiband and/or multi-region radiofrequency system or radiofrequency architecture that comprises a switch that enables the device to provide coverage at the different frequency bands or frequency regions of operation and to provide large bandwidths by commuting operation between sub-bands within the frequency bands or the frequency regions of operation. In the context of this document, a frequency band refers to a range of frequencies used by a particular wireless communication standard, as for example cellular communication standards or NB-IoT communication standards, but no limited to those; while a frequency region refers to a continuum of frequencies of the electromagnetic spectrum. For example, the NB-IoT B20 band is allocated in a frequency band going from 791 MHz to 862 MHz; and the NB-IoT B8 band is allocated in a frequency band going from 880 MHz to 960 MHz. A wireless device operating in the NB-IoT B20 and the NB-IoT B8 bands operates in a frequency region going from 791 MHz to 960 MHz. A wireless device that additionally operates at the NB-IoT B3 band, going from 1710 MHz to 1880 MHz, operates in two different frequency regions, a first frequency region going from 791 MHz to 960 MHz and a second frequency region going from 1710 MHz to 1880 MHz.

In some radiating system embodiments, the radiofrequency system advantageously comprises only-one or a single switch, the radiofrequency system providing operation at the at least two frequency regions and/or at the at least two frequency bands of operation of the wireless device. Some of the advantages of these only-one switch embodiments are the reduction of the losses related to the radiofrequency system and its simplification, with less components, leaving more space for other circuit components as well as easing the integration of the radiofrequency system in the radiating system and in the wireless device.

A radiofrequency system disclosed herein comprises a switch and at least two matching networks selectable through the switch, the at least two matching networks including two stages or parts, a pre-matching part or stage comprising at least one pre-matching circuit element or component, and a common matching part or stage, comprising at least one circuit element or component, the at least two pre-matching stages comprised in the at least two matching networks being connected to the common stage. The switch selects a matching network of the at least two matching networks comprised in the radiofrequency system and connects at least one of the booster elements or a modular multi-stage element comprised in the radiating system to the RF transceiver. In some embodiments, one or more pre-matching stages are common to at least two matching networks of the radiofrequency system. In the context of this document, a pre-matching part or stage refers to at least a circuit element or component included in a first or initial part or stage of a matching network. A common matching stage or part refers to at least a circuit element or component that is common to at least two matching networks, so that, the part or stage contains the same components for those at least two matching networks. Some embodiments of a radiofrequency system disclosed herein comprise pre-matching elements or components advantageously included in pre-matching network topologies comprising components that are not connected to ground, being advantageously included in series configuration. The different matching networks included in the radiofrequency system provide impedance matching for each frequency band or region of operation of the wireless device comprising the radiofrequency system.

In some embodiments, the pre-matching stages included in the radiofrequency system are advantageously comprised between a booster element or radiation booster or a modular multi-stage element, comprised in the radiating system that also comprises the radiofrequency system, and the switch. In those embodiments the switch is MPNT and at least two throws T are connected to at least two pre-matching stages and at least one pole P is connected to the common stage. In other embodiments, the pre-matching stages included in the radiofrequency system are comprised between the switch and a common matching stage. In those embodiments the switch is MPNT and at least one pole P is connected to the booster element or the modular multi-stage element and at least two pre-matching stages are connected to at least two throws T. Quite surprisingly, it has been found that better radiation and antenna efficiencies are achieved for a radiating system that comprises pre-matching stages between the booster element or the modular multi-stage element and the switch than those obtained for a radiating system comprising pre-matching stages after the switch and before the common matching stage.

The pre-matching and common stages comprised in a radiofrequency system disclosed herein comprise circuit elements or components that are, in some embodiments, passive components, as for example passive reactive components, being, in other embodiments, active components, as for example tunable elements as tunable reactive components such as tunable capacitors and/or tunable inductors, or, in other embodiments, those circuit elements can be diodes or transmission lines, those elements not being limited to those components.

Other radiofrequency system embodiments comprised in a wireless device disclosed herein include more than one switch. And among those embodiments including more than one switch, some of them comprise at least one multi-region switch, defined as a switch that is configured for providing operation at different frequency regions. Typically, a multi-region switch according to this disclosure is comprised in a radiofrequency system comprising at least two pre-matching stages and a common matching stage, as described for the previous embodiments.

A radiating system disclosed herein also comprises a feeding architecture that connects the booster or boosters included in the radiating system to the multiband and/or multi-region radiofrequency system comprising a switch. Typically, a feeding architecture comprised in a radiating system disclosed herein comprises a feeding line connected to a radiation booster, and comprises at least two feeding line extensions, comprising transmission lines in some embodiments, advantageously comprising strip lines in some of them, those feeding line extensions being connected to the switch and to the feeding line that is connected to a radiation booster. In some embodiments, in those comprising pre-matching elements between at least one booster and the switch, the switch is connected to the different feeding line extensions through those pre-matching elements or components. In other embodiments, in those comprising pre-matching elements between the switch and a common matching part, the switch is directly connected to the different feeding line extensions, typically through switch pads.

Some radiofrequency system embodiments disclosed herein also comprise an isolating element, the isolating element included for avoiding interference between signals flowing through at least two feeding line extensions that may be comprised in the feeding architecture for connecting the booster element or the modular multi-stage element to the switch. The isolating element is connected to a feeding line comprised in the feeding architecture and to the feeding line extensions, the feeding line being connected to a booster element or a modular multi-stage element. Normally, each feeding line extension provides operation at a frequency region of operation. In some embodiments, this isolating element includes or is a filtering element, which blocks the signal transmission at some specific frequencies through the feeding line extension or extensions that provide matching and operation at frequencies different from the blocked ones. Surprisingly, the isolating element isolates the branches or extensions between them in such a way that it restores the impedance values obtained along the feeding line extensions for the different frequency regions of operation, so that the different extensions are not charging the others.

Other embodiments of a radiating system disclosed herein comprise more than one, i.e. at least two, booster elements, a radiofrequency system comprising a switch, advantageously being only one switch in some embodiments, and a matching network or a pre-matching stage connected to each booster element, so that each booster element contributes independently to the radiation performance at one frequency band of operation of the radiating system or the wireless device. In some of these embodiments, those booster elements are comprised in a single piece or component, the component being a modular multi-stage element in some embodiments. In the context of this disclosure, a radiation booster or booster element refers to a radiation booster described and defined in the patent documents U.S. Pat. No. 8,203,492 B2, U.S. Pat. No. 9,331,389 B2 and U.S. Pat. No. 10,236,561 B2, incorporated by reference herein in their entireties. Also, the entire disclosure of the patent application US 2020/176855 A1 is hereby incorporated herein by reference, where modular multi-stage elements are disclosed. One of the advantages of those embodiments, comprising more than one booster elements, is that they provide robustness to human interaction. Other embodiments comprising more than one booster elements are characterized by comprising at least a booster element connected to more than one pre-matching stages for providing multiband or multi-region operation with a single booster element. These radiating system embodiments, comprising more than one booster elements or radiation boosters, are advantageous for providing multi-region operation while reducing coupling between frequency bands or frequency regions, or reducing charging problems between feeding line extensions or branches in the feeding-architecture needed for connecting the boosters to the switch comprised in the radiofrequency system.

### BRIEF DESCRIPTION OF THE DRAWINGS

The mentioned and further features and advantages of the disclosed system become apparent in view of the detailed description which follows with some example embodiments, referenced by the accompanying drawings, given for purposes of illustration only and in no way meant as a definition of the limits of the invention.

FIG. 1 illustrates the charging problem between matching components comprised in the different matching networks comprised in a radiofrequency system including only-one switch. This problem appears when the matching networks are located between a booster element and the switch, and there are components connected to ground.

FIG. 2 shows an embodiment of a radiating system that comprises a radiofrequency system according to the present disclosure comprising some pre-matching elements between a booster element and an RF switch.

FIG. 3 shows an embodiment of a radiating system that comprises a radiofrequency system according to the present disclosure comprising some pre-matching elements between an RF switch and a common matching stage comprising matching elements common to the different matching networks included in the radiofrequency system. The switch is in this case connected to a booster element, without pre-matching elements in between.

FIG. 4 illustrates a transmission coefficient comparison obtained for the radiofrequency systems provided in FIG. 2 and FIG. 3, at a frequency sub-band of operation.

FIG. 5 shows an embodiment of a radiating system comprising a radiofrequency system according to the present disclosure that comprises a multi-path RF switch.

FIG. 6 shows a PCB layout embodiment corresponding to a radiofrequency system according to the present disclosure, comprising feeding line extensions and a switch layout.

FIG. 7 shows a PCB layout embodiment according to a radiating system related to the present disclosure, including pads for allocating a filter between two transmission line extensions connected to a feeding line.

FIG. 8 shows an embodiment of a radiating system related to the present disclosure, the radiating system comprising more than one booster elements connected to a switch, and wherein each booster element is connected to the switch through a matching network or a pre-matching stage.

FIG. 9 shows an embodiment of a radiating system according to the present disclosure, the radiating system comprising more than one booster elements connected to a switch, wherein the booster elements or radiation boosters are arranged within a ground plane clearance at a corner of the PCB.

FIG. 10 shows an embodiment of a radiating system that comprises a radiofrequency system, the radiating system comprising more than one booster elements, wherein one of them is connected to a plurality of matching networks.

FIG. 11 shows an embodiment of a radiofrequency system comprising a common pre-matching stage.

FIG. 12 shows an embodiment of a radiating system that comprises a radiofrequency system comprising some pre-matching elements between a booster element and an RF switch, the radiating system comprising an antenna component.

FIG. 13 shows an embodiment of a radiating system that comprises a radiofrequency system comprising some pre-matching elements between a booster element and an RF switch, the radiating system comprising a modular multi-stage element.

### DETAILED DESCRIPTION

As described before, in the context of the present disclosure, a wireless device providing operation at more than one frequency region and/or frequency band, the wireless device comprising a radiating system that comprises an RF transceiver, a radiation booster or booster element, a ground plane layer, at least an external port and a radiofrequency system comprising a switch is provided and disclosed. In some embodiments, only one switch is advantageously comprised in the radiofrequency system, which provides operation at the at least two frequency regions and/or at the at least two frequency bands of operation of the wireless device.

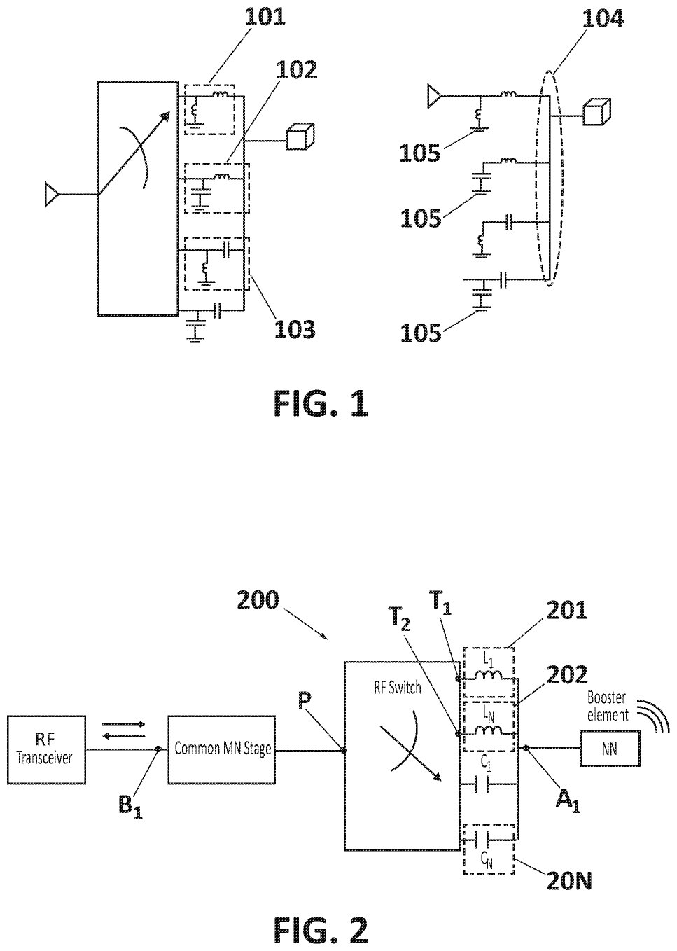

In FIG. 1, the problem that arises when only one switch is included in a multiband or multi-region radiofrequency system is shown. When mounting such a radiofrequency system, which comprises more than one matching network, for example 101, 102 and 103 in FIG. 1, for covering different sub-bands of operation, a charging problem may appear between the matching circuit components comprised in the different matching networks, because the different matching networks are connected between them (see 104). The problem appears particularly when those matching circuit components are included in a network topology comprising components connected to ground (see 105).

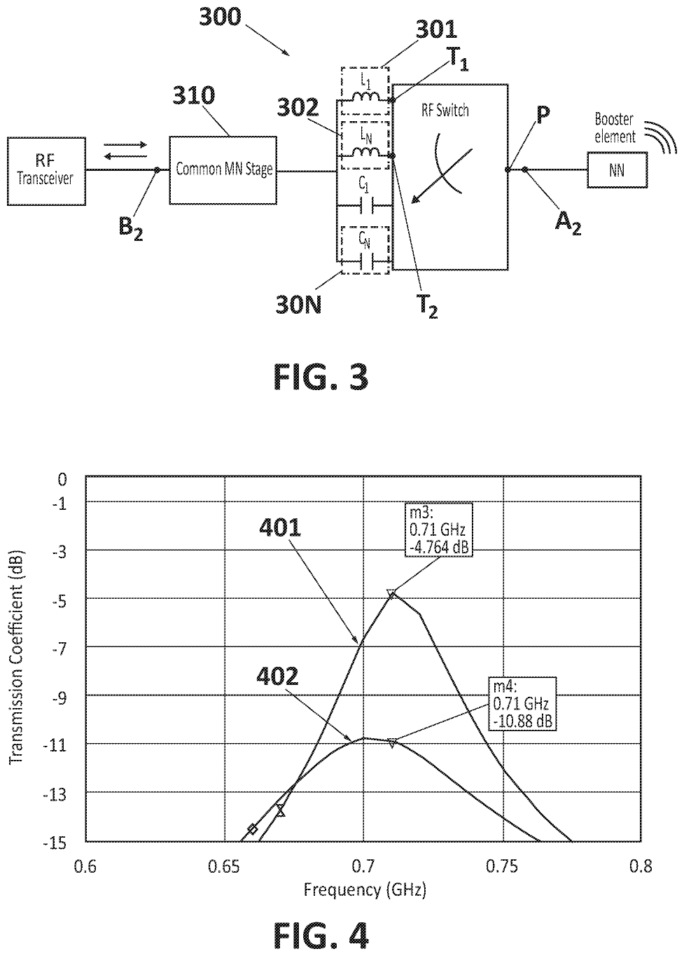

FIG. 2 and FIG. 3 provide embodiments of a radiating system 200, 300 comprising a radiofrequency system according to the present disclosure. In an embodiment from FIG. 2, the pre-matching stages 201 to 20N included in the radiofrequency system are advantageously disposed between a booster element of the radiating system and the RF switch. In this embodiment, the switch is a single pole multiple throw (SPNT) switch and at least two throws T₁, T₂ are connected to at least two pre-matching stages and one pole P is connected to the common stage, which is also connected to an RF transceiver. In the embodiment shown in FIG. 3, the pre-matching stages 301 to 30N included in the radiofrequency system are disposed between the RF switch and the common matching stage 310 that is connected to an RF transceiver. In this embodiment, the switch is SPNT and one pole P is connected to the booster element, and at least two pre-matching stages are connected to at least two throws T₁, T₂. It has been found that connecting the pre-matching stages to the booster element and to the switch, and the common matching stage between the switch and the RF transceiver, as it is the case for the embodiment of FIG. 2, provides better radiation and antenna efficiencies of the radiating system. FIG. 4 provides the transmission coefficient at a low frequency band of, for example, mobile frequencies, obtained for two radiating system embodiments comprising radiofrequency systems like the ones illustrated in FIG. 2 and FIG. 3. Curve 401 represents the transmission coefficient obtained for an embodiment from FIG. 2 from point A1 to point B1, and curve 402 represents the transmission coefficient obtained for an embodiment from FIG. 3 from point A2 to point B2. It is observed better or higher transmission coefficient for the embodiment from FIG. 2, more particularly, around 6 dB higher at 710 MHz for the examples used in the comparison provided in FIG. 4. A better transmission coefficient of the radiofrequency system means having less radiofrequency system losses and, consequently, better radiation and antenna efficiencies of the radiating system.

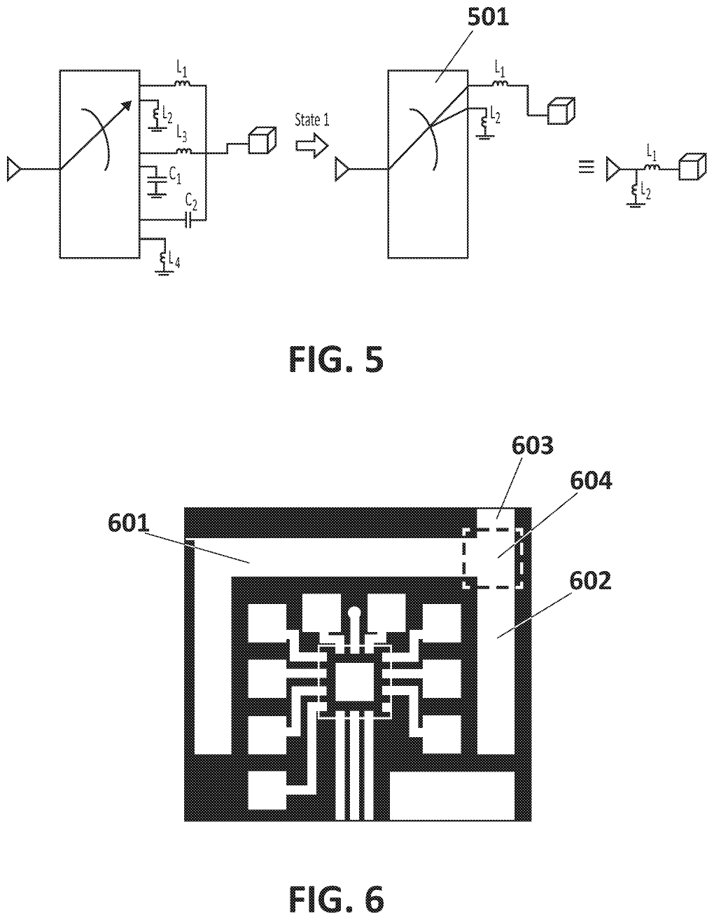

FIG. 5 provides another radiating system embodiment characterized by including a multi-path RF switch 501 in the radiofrequency system that allows a pre-matching stage to comprise elements connected to ground, as for example electronic components connected in parallel configuration, without creating charging problems between pre-matching elements and stages.

FIG. 6 provides a PCB layout embodiment corresponding to a radiofrequency system that is integrated in a real PCB. At least two feeding line extensions, particularly two 601 and 602 for this example, are comprised for connecting a booster element or radiation booster to the switch, the extensions being connected to a feeding line 603 that is connected to the radiation booster or booster element. Each feeding line extension provides operation at a frequency region of operation. In some embodiments, the radiofrequency system includes an isolation element, such as a filter, included in some embodiments in a position between the feeding line and the feeding line extensions (see 604), so that the isolation element is connected to the feeding line and to the feeding line extensions. It has been found that the isolation element or filter restores the impedance obtained along at least one feeding line extension for at least one frequency region of operation, so that the different extensions are not charging the others. Some radiating system embodiments do not include any isolation element for isolating the feeding line extensions between them.

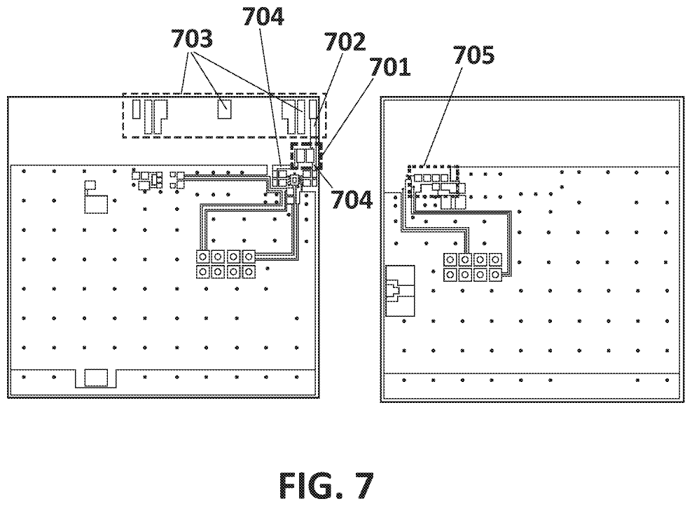

FIG. 7 provides another PCB layout embodiment, top and bottom layers, corresponding to the integration of a radiofrequency system in a real PCB. This radiofrequency system comprises a filter that is allocated in the layout pads 701, connected to two feeding line extensions 704 that are connected to a booster element feeding line 702. The layout pads 703 correspond to the pads of a modular multi-stage element, particularly a TRIO mXTEND™ component that comprises one booster element. The filter allows to isolate the two feeding line extensions between them at some specific frequencies, allowing the radiating system to provide multi-region operation. At the bottom layer of the PCB layout, the pads 705 needed for allocating a common matching stage comprised in the radiofrequency system are included. Typically, a PCB layout corresponding to a radiofrequency system that comprises a switch comprises control lines for configuring the switch and pads for connecting the pins or ports of the switch. In some embodiments, the common matching stage and its corresponding pads are allocated at the top layer.

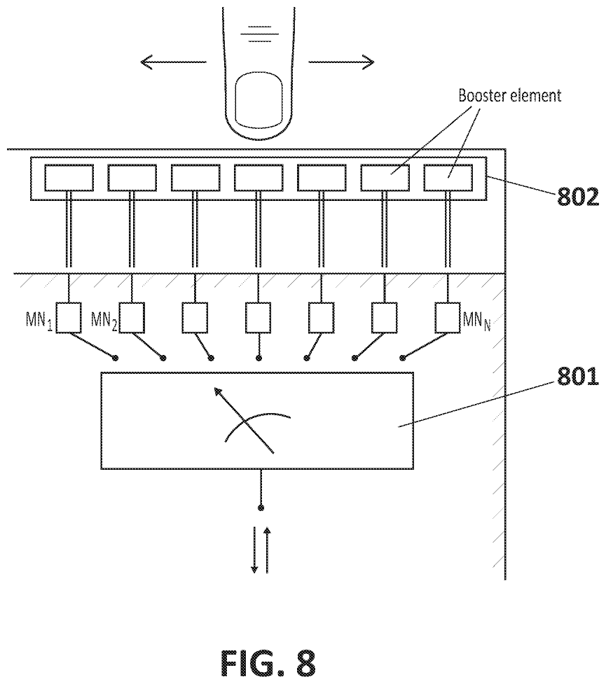

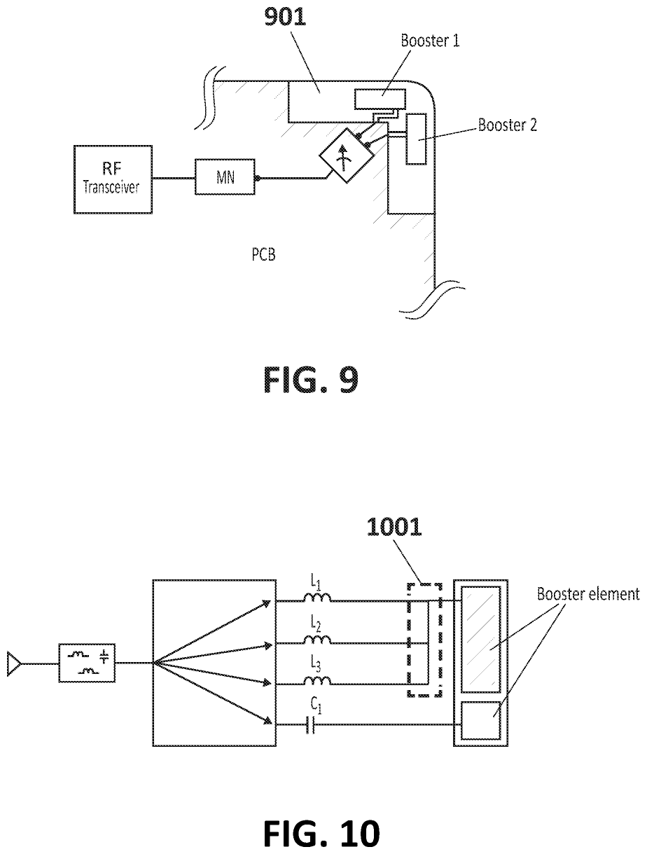

Other embodiments of a radiating system are provided in FIG. 8 and FIG. 9. These radiating systems comprise more than one booster elements and a radiofrequency system comprising only one switch 801, wherein each booster element is connected to a matching network MNi to MNN or a pre-matching stage comprised in a matching network of the radiofrequency system, so that each booster element contributes independently to the radiation performance at one band of operation of the radiating system or the wireless device. In some embodiments, those booster elements are comprised in a single piece or component 802, as shown in FIG. 8. In an embodiment from FIG. 9, the booster elements or radiation boosters are arranged within a ground plane clearance 901 from a ground plane layer at a corner of the PCB. One of the advantages of an embodiment like the one provided in FIG. 8 or FIG. 9 is that it provides robustness to human interaction.

FIG. 10 presents a radiating system that also comprises more than one booster element, but wherein one of them is connected to more than one 1001 matching network for providing multi-band or multi-region operation. A radiating system comprising more than one booster element or radiation booster, like the one shown in FIG. 10, is an advantageous solution for providing multi-region operation while reducing coupling or charging problems between the different frequency regions of operation.

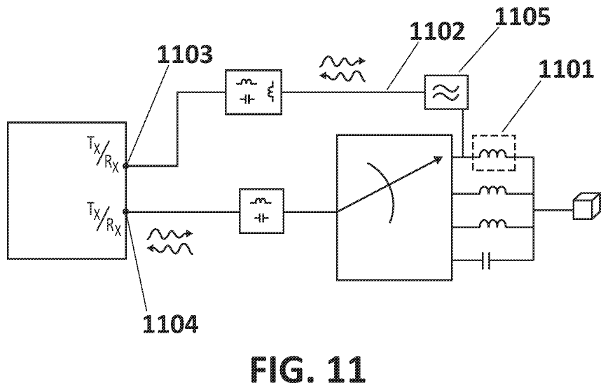

FIG. 11 provides a radiofrequency system that comprises a common pre-matching stage 1101 included in more than one matching network comprised in the radiofrequency system. More concretely, the radiofrequency system provided in FIG. 11 is comprised in a radiating system that includes more than one external port, particularly two, connected to first and second ports comprised in an RF transceiver, wherein one external port 1104 operates at a first frequency band or frequency region and the other external port 1103 operates at a second frequency band or frequency region. In a more particular example, the first port 1104 operates at mobile or cellular bands and the second port 1103 operates at GPS bands. The signal paths that comprise the common pre-matching stage are isolated between them by an isolating element or a filter 1105, more concretely for the example operating at GPS and mobile frequencies a GPS band-pass filter 1105 is included in the GPS path 1102 for blocking the signal at other frequencies different from GPS frequencies.

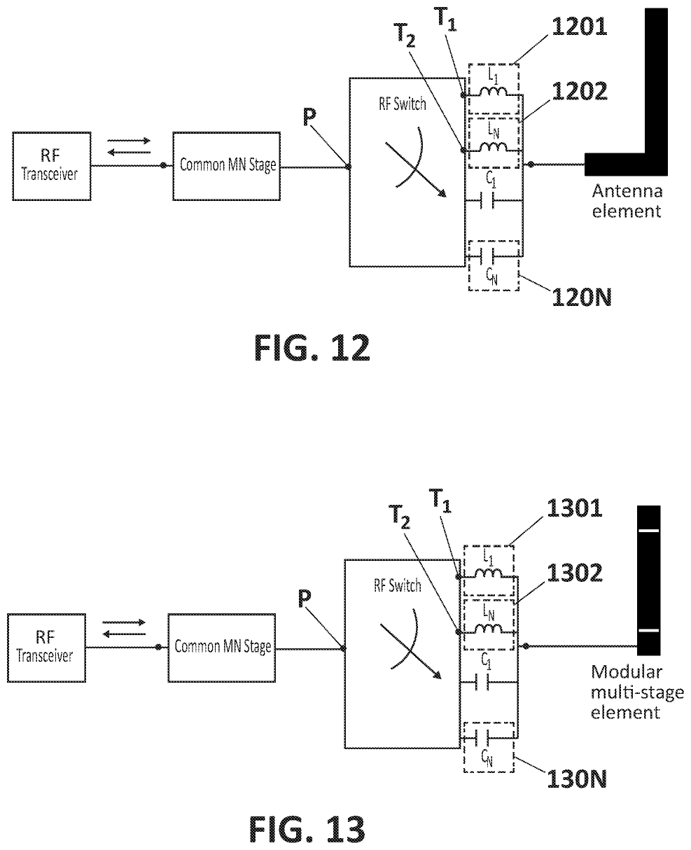

It has been found that this particular radiofrequency architecture comprising a switch and at least two matching networks including two stages or parts: a pre-matching stage and a common matching stage, is also suitable and beneficial for antenna systems including a radiating antenna component (see FIG. 12), such antenna preferably being non-resonant within the operating frequency bands when disconnected from the radiofrequency system. FIG. 13 provides an example of a radiofrequency system comprised in a radiating system that comprises a modular multi-stage element.

What is claimed is:

1. A wireless device comprising a radiating system that comprises:
a booster element;
a ground plane layer;
an RF transceiver; and
a radiofrequency system comprising:
a common matching stage coupled at one end to the RF transceiver;
a first pre-matching stage coupled at one end to the booster element;
a second pre-matching stage coupled at one end to the booster element; and
a single pole multiple throw (SPNT) switch having a pole P connected to the common matching stage, a first throw T₁ connected to the first pre-matching stage, and a second throw T₂ connected to the second pre-matching stage, wherein:
a first matching network to connect the RF transceiver to the booster element comprises the common matching stage and the first pre-matching stage connected by the switch via the first throw;
a second matching network to connect the RF transceiver to the booster element comprises the common matching stage and the second pre-matching stage connected by the switch via the second throw; and
the first and second matching networks are selectable via the switch to provide operation of the radiating system at two or more frequency regions.

2. The wireless device of claim 1, wherein the radiating system further comprises a feeding architecture that connects the booster element to the radiofrequency system, the feeding architecture comprising:
a feeding line connected to a radiation booster; and
at least two feeding line extensions that are connected to the switch and to the feeding line.

3. The wireless device of claim 1, wherein each of the first and second pre-matching stages comprises an inductor.

4. The wireless device of claim 1, wherein the first pre-matching stage comprises an inductor and the second pre-matching stage comprises a capacitor.

5. The wireless device of claim 1, wherein each of the first and second pre-matching stages comprises a series electronic component.

6. A wireless device of claim 1, wherein the first pre-matching stage comprises a series inductor.

7. The wireless device of claim 1, wherein the first pre-matching stage comprises a series capacitor.

8. The wireless device of claim 1, wherein the first pre-matching stage is common to more than one matching network of the radiofrequency system.

9. The wireless device of claim 1, wherein:
the first pre-matching stage is common to more than one matching network of the radiofrequency system; and
the RF transceiver comprises first and second ports.

10. The wireless device of claim 9, wherein the radiating system operates at mobile bands and at GPS bands.

11. The wireless device of claim 1, wherein the throws T₁, T₂ are connected to two or more booster elements.

12. The wireless device of claim 11, wherein each of the first and second pre-matching stages comprises an inductor.

13. The wireless device of claim 11, wherein the first pre-matching stage comprises an inductor and the second pre-matching stage comprises a capacitor.

14. The wireless device of claim 11, wherein each of the first and second pre-matching stages comprises a series electronic component.

15. The wireless device of claim 11, wherein the first pre-matching stage comprises a series inductor.

16. The wireless device of claim 11, wherein the first pre-matching stage comprises a series capacitor.

17. A wireless device comprising a radiating system that comprises:
a booster element;
a ground plane layer;
an RF transceiver; and
a radiofrequency system comprising:
a common matching stage coupled at one end to the RF transceiver;
a first pre-matching stage coupled at one end to the common matching stage;
a second pre-matching stage coupled at one end to the common matching stage; and
a single pole multiple throw (SPNT) switch having a pole P connected to the booster element, a first throw T₁ connected to the first pre-matching stage, and a second throw T₂ connected to the second pre-matching stage, wherein:
a first matching network to connect the RF transceiver to the booster element comprises the common matching stage and the first pre-matching stage connected to the booster element by the switch via the first throw;
a second matching network to connect the RF transceiver to the booster element comprises the common matching stage and the second pre-matching stage connected to the booster element by the switch via the second throw; and
the first and second matching networks are selectable via the switch to provide operation of the radiating system at two or more frequency regions.

18. The wireless device of claim 17, wherein each of the first and second pre-matching stages comprises an inductor.

19. The wireless device of claim 17, wherein each of the first and second pre-matching stages comprises a series electronic component.

20. The wireless device of claim 17, wherein the first pre-matching stage comprises an inductor and the second pre-matching stage comprises a capacitor.
